(19) United States
(12) Patent Application Publication
(10) Pub. No.: US 2006/0070815 A1
(43) Pub. Date: Apr. 6, 2006

(54) Lift assembly

(76) Inventor: Michael Nees, Seekonk, MA (US)

Correspondence Address: KEVIN J. MCNEELY, ESQ., 5335 WISCONSON AVENUE, NW, SUITE 440, WASHINGTON, DC, 20015, US

(21) Appl. No.: 11/192,397

(22) Filed: Jul. 29, 2005

Related U.S. Application Data
(60) Provisional application No. 60/591,873, filed on Jul. 29, 2004.

(51) Int. Cl. B66F 7/12

(52) U.S. Cl. 187/213

(57) ABSTRACT

A lift assembly includes a first vertical support column and a second vertical support column attached to the top of the first vertical support column. A support assembly is attached to a lift carriage that travels vertically inside the first and second support columns. The lift carriage has elongated rub blocks that contact the inner walls of the columns.

### CROSS-REFERENCE TO RELATED APPLICATION

This patent application claims priority to U.S. provisional patent application Ser. No. 60/591,873 filed on Jul. 29, 2004, and is incorporated by reference herein.

### TECHNICAL FIELD

The present invention relates to lift devices and, more particularly, to automotive lift devices.

### BACKGROUND

Lift devices are used to lift heavy items, such as, for example, automobiles and trucks. Once the automobile is raised on the lift, the undercarriage is exposed in order to perform maintenance and repairs.

A conventional lift assembly consists of two vertical columns that are spaced at a distance somewhat wider than the width of the automobile. The columns are bolted to the floor and a moveable lift carriage or lift carriage is fitted inside each column. Four ultra-high molecular weight plastic spacers or sliders are mounted to the outer walls of the lift carriage, which keeps the lift carriage walls aligned relative to the interior of the column walls. Each slider has a hemispherical shape and a flat portion that is mounted to the carriage wall. As the sliders wear, the lift carriage can become misaligned inside the columns.

Lift arms extend from a channel in the wall of the column and can be extended and/or rotated to a position beneath a sturdy portion of the undercarriage of a vehicle. Cables are attached to each carriage and extend upward inside the columns. Typically, one of the cables is routed through a crossbar attached either to the top or the bottom of the columns so that the cables can be routed to a pulley driven by a common motor which is attached to the opposite carriage for the purposes of equalization. The motor actuates hydraulic cylinders which are operated to raise or lower the position of each carriage.

The columns are generally between 8 and 12 feet long. The column height is selected based on the height of the ceiling and/or the amount of travel needed by the lift arms in order to access the underside of a vehicle. The length of the columns can cause shipping to be difficult and/or expensive. For example, heavy products are usually shipped in crates that are approximately four feet long so that they can be handled by forklifts and other moving equipment. The 8-12 foot long column requires a much larger shipping crate adding to expense and difficulty in handling the product for purposes of shipment. In addition, 8-12 foot long steel columns are extremely heavy. Thus, once the shipment arrives, it can be extremely difficult for the purchaser to move the columns to a desired location.

### SUMMARY

In one general aspect, a lift assembly includes a first vertical support column and a second vertical support column attached to the top of the first vertical support column. A support assembly is attached to a lift carriage that travels vertically inside the support columns.

Embodiments may include one or more of the following features. For example, the lift carriage may have rub blocks in each corner, with each rub block being substantially the same height, such as, for example, 90 percent of the height of the lift carriage. The rub blocks contact the inner walls of the first and second vertical support columns. The rub blocks may be made of a ultra high molecular weight nylon or plastic material.

Each of the support columns can be about 48 inches and may have vertical channels. In other embodiments, the support columns have different heights and there may be more than two vertically aligned support columns for taller applications. A support member extends through the column channels and attaches the lift carriage to the support assembly. The support columns may also have connector plates with mating surfaces in order to attach the columns together.

The support assembly may have a pair of telescoping lift arms. A cable and pulley system may be installed inside the vertical support columns to raise and lower the lift carriage and the support assembly.

Lift catches may run vertically down the support columns and the support assembly may have a locking mechanism that can be inserted into one of the lift catches to lock the position of the support assembly. A third vertical support column may be attached to the second vertical support column and may be configured so that the lift carriage travels vertically inside the first, second and third vertical support columns.

In another general aspect, a lift assembly includes a first vertical support column, a second vertical support column attached to the top of the first vertical support column, a lift carriage configured to travel vertically inside the first and second vertical support columns, a support assembly having a pair of lift arms that can be positioned beneath the undercarriage of a vehicle, and a support member attaching the lift carriage to the support assembly.

Embodiments may include one or more of the above or following features. For example, the lift carriage may have rub blocks that are substantially the same height as the lift carriage as described above.

In a further general aspect, a method of installing a lift assembly that includes a first vertical support column, a second vertical support column, and a lift carriage attached to a support assembly includes inserting the lift carriage into the first vertical support column and attaching the second vertical support column to a top of the first vertical support column. The method may include other procedures, such as, for example, attaching a bottom of the first vertical support column to the floor, preferably, a hard surface such as concrete.

In an improved lift assembly of the present invention, the column is split into two sections that are bolted together at a mating surface. The lift assembly can then be packed into a much smaller moving crate and the weight of each column section is approximately half the weight of the standard column.

The rub blocks have an elongated shape substantially the length of the lift carriage. Thus, each rub block has a larger surface area in contact with the interior column wall such that it slides more smoothly even when worn and easily travels over any imperfect surface, such as, for example, a seam at the mating surface of the two column sections.

### DESCRIPTION OF DRAWINGS

FIG. 1 shows an automobile raised on a lift device, the automobile shown in dashed lines;

FIG. 2 is a cut-away view of a lift assembly; and

FIG. 3 shows a lift carriage attached to a support assembly.

### DESCRIPTION

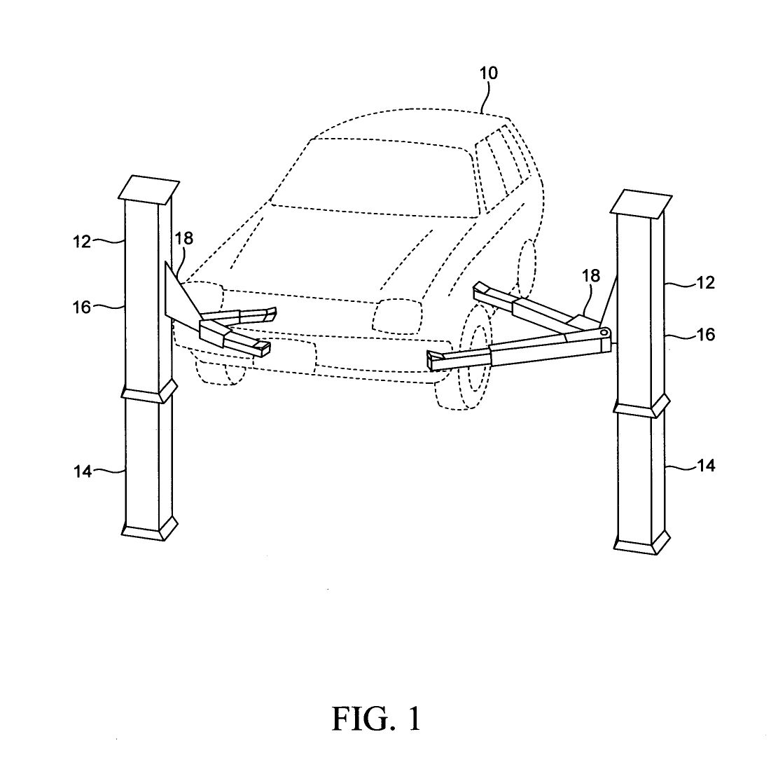

Referring to FIG. 1, an automobile 10, shown in phantom lines, is raised off the floor by lift assemblies 12. The lift assemblies 12 include lower and upper support columns 14, 16. The under carriage of the automobile 10 is supported by support assemblies 18 that ride vertically on the support columns 14, 16.

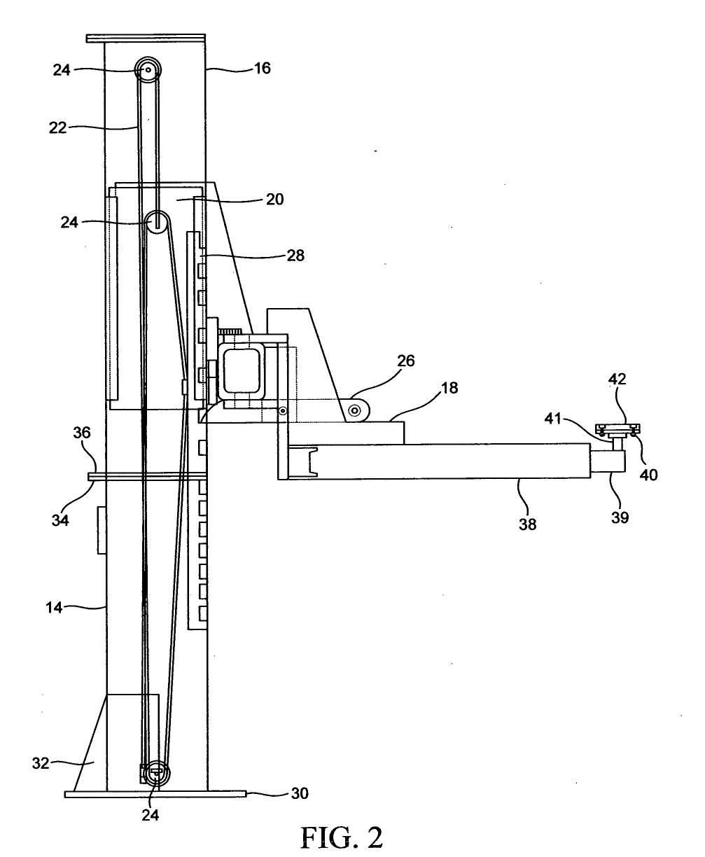

Referring to FIG. 2, the support assembly 18 is attached to a lift carriage 20 which moves vertically inside the columns 14, 16. The position of the lift carriage 20 is adjusted by a cable 22 which is guided by pulleys 24. The cable 22 can be extended and retracted by, for example, a hydraulic cylinder with a 36 inch stroke. A locking mechanism 26 that prevents rapid descent is inserted into locking catches 28 thereby preventing the support assembly from being lowered until the locking mechanism 26 is disengaged. The locking mechanism 26 is disengaged via a weighted counterbalance.

The lift assembly 12 is mounted to the floor by a bottom plate 30 and additional strength is provided near the floor by an outrigger plate 32. The upper lower and upper support columns are fixed together by connector plates 34, 36. Each support column 14, 16 is less than slightly less than 48 inches in height for ease of shipping in a crate that is about four feet long. In other embodiments, the upper and lower columns may be different heights, such as, for example, 60 or 72 inches. Since 8 to 12 foot long steel columns can be extremely heavy, the ability to separate the two support columns 14, 16 makes moving the columns 14, 16 to a desired location much easier.

The support assembly 18 includes a set of lift arms 38 with telescoping extension arms 39 that can be adjusted to fit the undercarriage of a vehicle. A contact plate 40 is attached to the top of a pedestal 41 at the end of the extension arm 39 and a rubber pad 42 is mounted to the top of each contact plate 40.

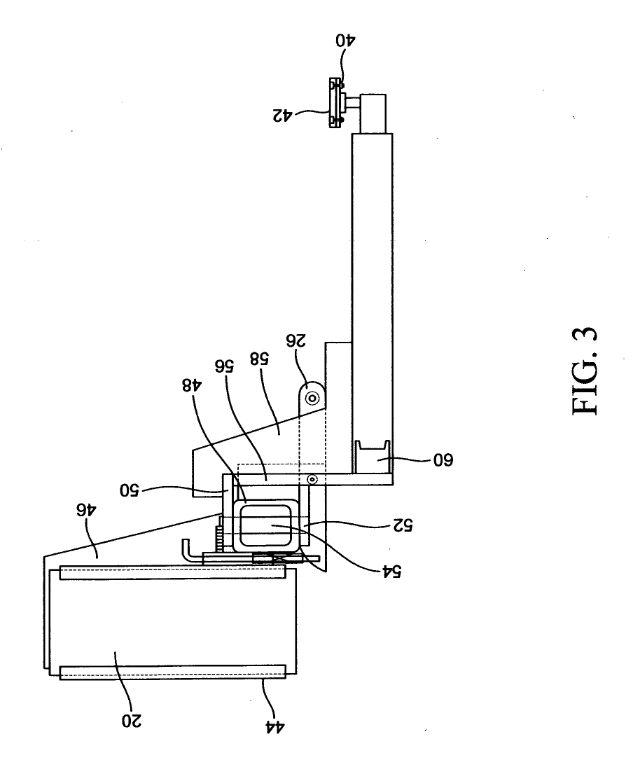

Referring to FIG. 3, rub blocks 44 wrap around the comers of each lift carriage 20. The rub blocks 44 are substantially the same height as the lift carriages. Thus, as the rub blocks 44 move within the columns during lifting and lowering procedures, the lift carriage 20 continues to maintain a properly aligned vertical position inside the support columns 14, 16 and easily slide over any imperfect surface, such as, for example, a seam at the mating surface of the two columns 14, 16. In addition, the substantially longer rub blocks 44 distribute the loading over the entire length of the lift carriage 20.

A support member 46 is attached to the lift carriage 20. The support member 46 attaches to a cross beam 48. Upper and lower plates 50, 52 are attached to the cross beam by a pin 54. The upper and lower plates 50, 52 are fixed to a cross plate 56 which is fixed to an arm support member 58. Each lift arms 38 attaches to the arm support member 58 by a hinge.

While the present invention has been particularly described with reference to the preferred embodiments, it should be obvious to those of ordinary skill in the art that modifications in form and details may be made without departing from the spirit and scope of the invention.

I claim:

1. A lift assembly, comprising:
a first vertical support column;
a second vertical support column attachable to a top of the first vertical support column; and
a support assembly having a lift carriage that travels vertically inside the first and second support columns.

2. The lift assembly of claim 1, wherein the lift carriage includes a rub block at each corner of the lift carriage, each rub block being substantially the same height of the lift carriage and contacting an inner wall of the first and second support columns.

3. The lift assembly of claim 2, wherein the rub block having substantially the same height of the lift carriage includes a height of more than 90 percent of the height of the lift carriage.

4. The lift assembly of claim 2, wherein the rub block comprises an ultra high molecular weight plastic.

5. The list assembly of claim 1, wherein:
the first vertical support column defines a first channel;
the second vertical support column defines a second channel; and
the support assembly comprises a support member that extends through the first and second channels and attaches the lift carriage to the support assembly.

6. The lift assembly of claim 1, wherein:
the first vertical support column includes a first connector plate;
the second vertical support column includes a second connector plate; and
the first vertical support column attaches to the second vertical support column being by attaching the first connector plate and the second connector plate.

7. The lift assembly of claim 1, wherein the first vertical support column and the second vertical support column each have a height of about 48 inches.

8. The lift assembly of claim 1, wherein the support assembly comprises a pair of telescoping lift arms.

9. The lift assembly of claim 1, further comprising a cable and pulley system inside the first and second vertical support columns, the cable and pulley system being connected to the lift carriage to raise and lower the support assembly.

10. The lift assembly of claim 1, wherein:
the first vertical support column defines first lift catches and the second vertical support column defines second lift catches; and
the support assembly comprises a locking mechanism insertable in one of the first and second lift catches to lock the position of the support assembly.

11. The lift assembly of claim 1, further comprising:
a third vertical support column attachable to the second vertical support column;
wherein the lift carriage travels vertically inside the first, second and third vertical support columns.

12. A lift assembly, comprising:
a first vertical support column;
a second vertical support column attached to a top of the first vertical support column;
a lift carriage configured to travel vertically inside the first and second vertical support columns;
a support assembly having a pair of lift arms positionable beneath the undercarriage of a vehicle; and
a support member attaching the lift carriage to the support assembly.

13. The lift assembly of claim 12, wherein the lift carriage comprises rub blocks having a height substantially the same height as the lift carriage.

14. A method of installing a lift assembly having a first vertical support columns, a second vertical support column, and a lift carriage attached to a support assembly, the method comprising:
inserting the lift carriage into the first vertical support column; and
attaching the second vertical support column to a top of the first vertical support column.

15. The method of claim 14, further comprising:
attaching a bottom of the first vertical support column to a floor.
